(19) United States
(12) Patent Application Publication
(10) Pub. No.: US 2026/0008080 A1
(43) Pub. Date: Jan. 8, 2026

(54) TILES THAT GLOW IN DARK

(71) Applicants: Reshma N. Kheraj, Dunwoody, GA (US); Naresh Pulipati, Dunwoody, GA (US)

(72) Inventors: Reshma N. Kheraj, Dunwoody, GA (US); Naresh Pulipati, Dunwoody, GA (US)

(21) Appl. No.: 19/288,716

(22) Filed: Aug. 1, 2025

Related U.S. Application Data
(60) Provisional application No. 63/668,499, filed on Jul. 8, 2024.

(51) Int. Cl. B05D 5/06; B05D 7/00

(52) U.S. Cl. CPC B05D 5/06; B05D 7/53

(57) ABSTRACT

A tile structure that has self-glow properties and includes a base formed from conventional tile materials and a surface coating or integrated layer including luminescent compounds. The luminescent compounds absorb ambient light and emit visible light in low-light conditions without requiring an external power source. The tile may be used for flooring, roofing, interior decoration, or exterior applications, and may be formed in a variety of shapes, colors, and designs. The luminescent material may be applied over part or all of the exposed surface or mixed into the tile or both. Topcoats or sealants may be added to enhance durability, weather resistance, and waterproofing. The tiles provide both aesthetic and functional benefits, including improved visibility in darkness.

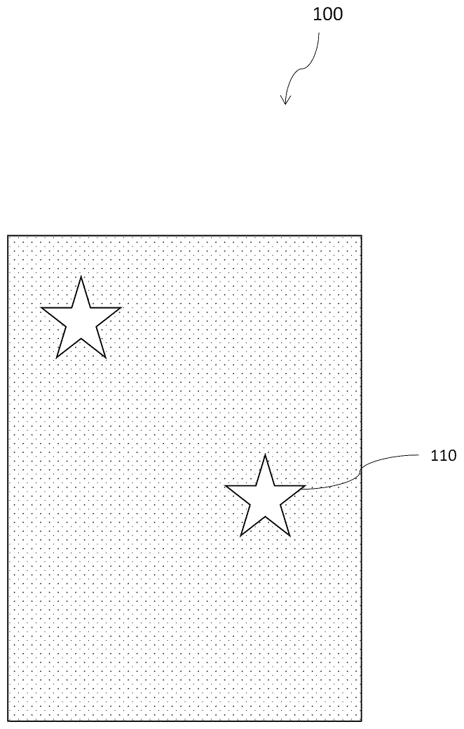

### CROSS REFERENCE TO RELATED APPLICATIONS

This application claims priority from a U.S. Provisional Patent Appl. No. 63/668,499, filed on Jul. 8, 2024, which is incorporated herein by reference in its entirety.

### FIELD OF INVENTION

The present invention relates to tiles for use in construction, and more particularly, the present invention relates to tiles that glow in darkness without any external power supply.

### BACKGROUND

Tiles are commonly used to cover constructed surfaces, such as floors, roofs, and pavements, serving both aesthetic and protective purposes. Due to their water-resistant properties, tiles help prevent seepage into the underlying structure, thereby protecting it from water damage. Additionally, tiles are rigid and durable, capable of withstanding heavy foot traffic. They can be manufactured in a variety of shapes and designs, offering an economical and visually appealing solution for covering floors and roofs. Shingle tiles, in particular, are widely used for roofing applications, providing both aesthetic appeal and protection against water infiltration.

For enhanced aesthetics, tiles may be fabricated in various shapes and sizes, and decorative designs may be applied to their surfaces. Numerous coatings and surface treatments are also known in the art to improve both the functional performance and visual appearance of tiles.

Accordingly, there is a recognized need for improved tile designs that enhance both performance and aesthetic value.

As used herein, the term “tiles” includes shingle tiles unless otherwise specified.

### SUMMARY OF THE INVENTION

The following provides a simplified summary of one or more embodiments of the present invention to facilitate a basic understanding of the subject matter. This summary is not intended to provide an exhaustive overview of all possible embodiments, nor to identify key or essential features of any embodiment. Rather, it is intended solely to introduce certain concepts in a simplified form as a prelude to the more detailed description that follows.

In one aspect, disclosed is a self-glowing tile that includes a base tile; and one or more coating layers applied to a top surface of the base tile, wherein the one or more coating layers or one or more portions of the one or more coating layers comprises self-glow material, wherein the self-glow material is configured to absorb ambient light and emit visible light in low-light conditions without requiring an external power source. The self-glow material comprises a phosphorescent compound. The phosphorescent compound is doped with a rare earth element. A protective topcoat may be incorporated to provide waterproofing, weather resistance, or durability. The one or more portions are in the form of a symbol, design, or geometric shape.

In one aspect, disclosed is a method for manufacturing a self-glowing tile, the method includes proving a base tile; and applying one or more coating layers over a top surface of the base tile, wherein the one or more coating layers or one or more portions of the one or more coating layers comprises self-glow material, wherein the self-glow material is configured to absorb ambient light and emit visible light in low-light conditions without requiring an external power source. The self-glow material comprises a phosphorescent compound. The phosphorescent compound is doped with a rare earth element. The method further comprises applying a protective topcoat to provide waterproofing, weather resistance, or durability. The one or more portions are in a form of a symbol, design, or geometric shape.

### BRIEF DESCRIPTION OF DRAWING

The accompanying FIGURE, which are incorporated herein, form part of the specification and illustrate embodiments of the present invention. Together with the description, the FIGURE further explain the principles of the present invention and to enable a person skilled in the relevant arts to make and use the invention.

The drawing shows a tile, according to an exemplary embodiment of the present invention.

### DETAILED DESCRIPTION

The subject matter described herein will now be explained in further detail with reference to the accompanying drawing, which form a part of this disclosure and illustrate specific exemplary embodiments. However, it should be understood that the subject matter may be embodied in various alternative forms. Accordingly, the claimed subject matter is not intended to be limited to the specific embodiments illustrated and described herein; these are provided merely for illustrative purposes. A broad scope of protection is intended. The subject matter may be embodied, for example, in the form of methods, devices, systems, or components. Therefore, the following detailed description is not intended to be restrictive or limiting in any way.

As used herein, the term “exemplary” is intended to mean “serving as an example, instance, or illustration.” Any embodiment described as “exemplary” is not necessarily to be construed as preferred or more advantageous than other embodiments. Similarly, references to “embodiments of the present invention” are not intended to require that all embodiments include the particular features, advantages, or operational modes discussed.

The terminology used in this disclosure is for the purpose of describing particular embodiments only and is not intended to be limiting. As used herein, the singular forms “a,” “an,” and “the” include plural forms unless the context clearly indicates otherwise. Additionally, terms such as “comprises,” “comprising,” “includes,” and “including” are intended to be inclusive and do not exclude the presence of additional elements, features, steps, components, or groups thereof.

The following detailed description sets forth the best currently contemplated mode or modes for carrying out the disclosed subject matter. This description is intended to illustrate, rather than limit, the principles and scope of the invention, which will be defined by the claims of any resulting patent.

The present invention relates to tiles having self-glow properties—i.e., tiles wherein at least a portion of the tile is capable of emitting visible light in the absence of an external power supply. The disclosed tiles may be employed in place of conventional tiles in various applications, including but not limited to roofing, flooring, cabinetry, kitchens, and general construction. The self-glow capability enhances both the functional utility and aesthetic appeal of the tiles. These tiles appear visually appealing in daylight and emit a visible glow in darkness, making structures such as homes, roofs, walls, and floors aesthetically distinctive during nighttime. The tiles are especially suited for spaces such as children's rooms, playrooms, bathrooms, patios, kitchens, decks, yards, pools, spas, playhouses, treehouses, closets, and basements. For example, an address plate of a building may incorporate the invention to make it easier to see the address at night.

In addition to their decorative properties, the self-glowing tiles can also serve a utilitarian purpose by illuminating pathways or flooring areas in the absence of external lighting, thereby improving visibility and safety.

The base tile may be manufactured using conventional materials and processes known in the art, including materials suitable for the intended application (e.g., indoor or outdoor use). A luminescent coating or surface layer containing self-glow materials may be applied to the base tile. The self-glow materials are capable of absorbing ambient light and gradually releasing it as visible light in dark conditions. These materials may be mixed with a coating formulation and applied to the tile surface. The resulting tiles may be rendered waterproof, weather-resistant, durable, and functional. Optional externally powered lighting elements may also be incorporated for additional aesthetic or practical enhancement, although such lighting is not necessary for the tile's self-glow effect. The tiles may be produced in various shapes, sizes, colors, and patterns, including incorporation of decorative designs, symbols, and surface textures. Tiles suitable for different applications, such as flooring or roofing, can be fabricated in accordance with the invention. The tiles may be used for both interior and exterior decorative purposes and can be customized to user preferences.

The self-glow material may be incorporated either into a portion of the tile's exposed (upper) surface or across the entire exposed surface. Furthermore, combinations of non-glowing and self-glowing tiles may be used in tiling installations to produce visually engaging patterns and designs.

The base tile may be fabricated from a variety of materials including, but not limited to, wood, ceramic, glass, asphalt, metals, alloys, plastic, stone, resin, fabric, clay, and brick.

The self-glow effect is imparted by luminescent materials, which may include phosphorescent pigments, or other suitable glow-in-the-dark compounds. Examples include zinc sulfide, strontium aluminate, and other phosphorescent compounds capable of storing and re-emitting light energy. Such materials may be doped with rare earth elements such as europium or dysprosium to enhance the brightness and duration of the emitted glow.

A suitable binding medium may be used to encapsulate the luminescent particles and facilitate their application onto or integration into the tile. The binding medium may be selected from acrylics, polyphenylene oxide (PPO) resins, epoxy resins, or other polymers known to provide strong adhesion, durability, and environmental resistance.

The luminescent material may be incorporated into the tile using various techniques, including mixing with a coating composition or applying as a surface layer via methods such as spraying, dipping, or blast coating. Additional protective sealants or topcoats may be applied to improve weather resistance, waterproofing, and overall longevity. Additives may be included to enhance properties such as viscosity, mechanical strength, safety, and ease of application. Both surface deposition and integration into the base material may be employed, individually or in combination, to produce tiles with diverse patterns, textures, and three-dimensional visual effects.

Referring to the drawing which shows a tile 100 including portions 110 that include the self-glow material. The portions 110 are in the form of stars. The portions containing the self-glow material can be manufactured in a range of patters and designs.

While the foregoing description sets forth what is presently considered to be the best mode for carrying out the invention and enables a person of ordinary skill in the art to make and use the invention, it will be understood and appreciated that various modifications, combinations, substitutions, and equivalents thereof may be made without departing from the scope and spirit of the invention. The disclosed embodiments, methods, and examples are provided by way of illustration and not limitation. Accordingly, the invention is not to be limited by the foregoing description but is to be defined by the claims that may be presented in any resulting patent, together with all legal equivalents thereof.

What is claimed is:

1. A self-glowing tile comprising:
a base tile; and
one or more coating layers applied to a top surface of the base tile, wherein the one or more coating layers or one or more portions of the one or more coating layers comprises self-glow material, wherein the self-glow material is configured to absorb ambient light and emit visible light in low-light conditions without requiring an external power source.

2. The self-glowing tile of claim 1, wherein the self-glow material comprises a phosphorescent compound.

3. The self-glowing tile of claim 2, wherein the phosphorescent compound is doped with a rare earth element.

4. The self-glowing tile of claim 1, further comprising a protective topcoat to provide waterproofing, weather resistance, or durability.

5. The self-glowing tile of claim 1, wherein the one or more portions are in a form of a symbol, design, or geometric shape.

6. A method for manufacturing a self-glowing tile, the method comprising:
proving a base tile; and
applying one or more coating layers over a top surface of the base tile, wherein the one or more coating layers or one or more portions of the one or more coating layers comprises self-glow material, wherein the self-glow material is configured to absorb ambient light and emit visible light in low-light conditions without requiring an external power source.

7. The method of claim 6, wherein the self-glow material comprises a phosphorescent compound.

8. The method of claim 7, wherein the phosphorescent compound is doped with a rare earth element.

9. The method of claim 6, wherein the method further comprises:
applying a protective topcoat to provide waterproofing, weather resistance, or durability.

10. The method of claim 6, wherein the one or more portions are in a form of a symbol, design, alphanumeric characters, and/or geometric shape.
